(19) United States
(12) Patent Application Publication
(10) Pub. No.: US 2008/0145703 A1
(43) Pub. Date: Jun. 19, 2008

(54) Multilevel Color Structure for a Metal Surface

(76) Inventor: Chih-Hsin LIU, Caotun Town (TW)

Correspondence Address: Dr. BANGER SHIA, 102 Lindencrest Ct., Sugar Land, TX, 77479-5201, US

(21) Appl. No.: 11/612,462

(22) Filed: Dec. 18, 2006

(51) Int. Cl. B32B 15/01

(52) U.S. Cl. 428/702

(57) ABSTRACT

A multilevel color structure is disclosed for a metal surface, comprising a Tio2 film plated on a surface of a metal piece. The Tio2 film varies in thickness to produce multilevel color variations through the effect of light refraction.

### BACKGROUND OF THE INVENTION

1. Field of the Invention

The present invention relates to a structure design for a metal surface, and more particularly to a multi-level color structure for a metal surface.

2. Description of the Prior Art

A metal piece is usually plated with a thin layer of film, or the metal surface of pure titanium is treated with high temperature oxidation to change the color of the film thereof; it could also be that the metal surface is painted with stove paint. However, all these methods have the following problems:

First of all, the above-mentioned methods can only produce a single monotonous color on a metal surface.

Secondly, anode high temperature oxidation damages the surface structure of the titanium and can not produce a mirror-like smooth surface. The pure titanium must be further treated with extra processes to produce a multi-color smooth surface. These extra processes always involve complicated processes, multiple tools, and high manufacture cost. In addition, it also entails significant changes in properties of the chemical additive for producing variations in colors.

Finally, the color on the pure titanium formed by high temperature oxidation is likely to fade away after strong impact, adversely effecting its durability.

Therefore, there comes a need for producing a multi-level color structure for a metal surface using uncomplicated tools and some materials to reduce manufacturing complexity and cost.

### SUMMARY OF THE INVENTION

The primary objective of the present invention is to provide a multi-level color structure for a metal surface, which can produce color variations on a metal surface with the help of simple tools and some materials.

A multilevel color structure for a metal surface in accordance with the present invention comprises a Tio2 film on a surface of a metal piece. The Tio2 film is inconsistent in thickness so that thickness variation of the Tio2 produces an effect of multilevel color variations through light refraction.

In addition, the metal piece is also provided with an uneven surface, and the uneven surface increases the thickness variation and complicacy of the Tio2 film, so as to produce more color variations on the surface of the metal piece.

It is to be noted that the present invention can produce color variation on a metal surface by using simple tools and material. For example, multi-level color structure for a metal surface in accordance with the present invention can be generated simply by using a plating and grinding tool to control the thickness of the Tio2 film plated on the surface of the metal piece.

### BRIEF DESCRIPTION OF THE DRAWINGS

FIG. 1 is a cross sectional view in accordance with the present invention of showing a part of a multi-level color structure on a metal surface;

FIG. 2 is a cross sectional view in accordance with another embodiment of the present invention of showing a part of a multi-level color structure on a metal surface;

FIG. 3 is a cross sectional view in accordance with a third embodiment of the present invention of showing a part of a multi-level color structure on a metal surface; and

FIG. 4 is a cross sectional view in accordance with a fourth embodiment of the present invention of showing a part of a multi-level color structure on a metal surface.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

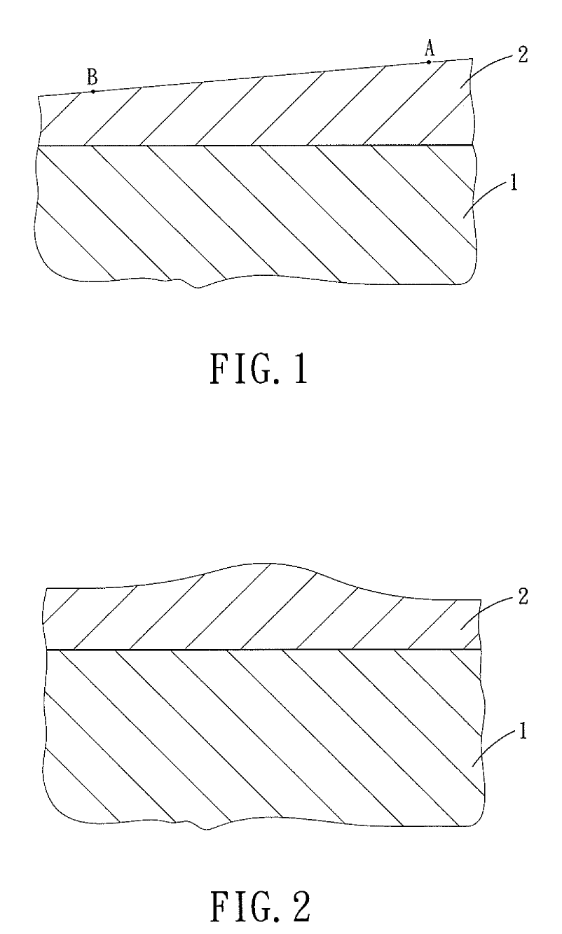

Referring to FIG. 1, which is a cross sectional view in accordance with the present invention of showing a part of a multi-level color structure on a metal surface, a metal piece 1 made of stainless steel is plated with a Tio2 film 2. The Tio2 film has at least one maximum thickens and a minimum thickness. The Tio2 film 2 with different thickness produces different colors through light refraction.

By such arrangements, as shown in FIG. 1, at the point A of the surface of the Tio2 film 2 where the thickness value is relatively great appears a specific color, at the same time, at the point B of the surface of the Tio2 film 2 where the thickness value is relatively small appears another specific color. Further, between the two specific colors there appears a gradated color which changes with the thickness of the Tio2 film 2.

Unlike the conventional methods, where the surface of the metal piece 1 can only be provided with a single color by oxidation, coating, stove painting, or it has to change the chemical agents in order to produce various colors, the multi-level color structure for a metal surface in accordance with the present invention can be obtained simply by using a plating and grinding tool to control the thickness of the Tio2 film 2 plated on the surface of the metal piece 1, and then the Tio2 film with different thickness can produce color level variations.

In addition, the present invention can use Cathode arc discharge ion plating to produce a Tio2 film 2 with a smooth surface, and the thickness variation of the Tio2 film 2 is not great and is almost unperceivable with naked eyes, but this embodiment can still produce color variations without causing such a visual effect that the surface thickness seems to be inconsistent. By such arrangements, the present invention can produce a metal piece with a smooth and multi-color surface with lost and simple process.

Referring to FIG. 2, which is a cross sectional view in accordance with another embodiment of the present invention of showing a part of a multi-level color structure on a metal surface, the difference of the embodiment in FIG. 2 over that in FIG. 1 is that the Tio2 film 2 is thick in the middle and thin at both sides, and the color varies with the thickness.

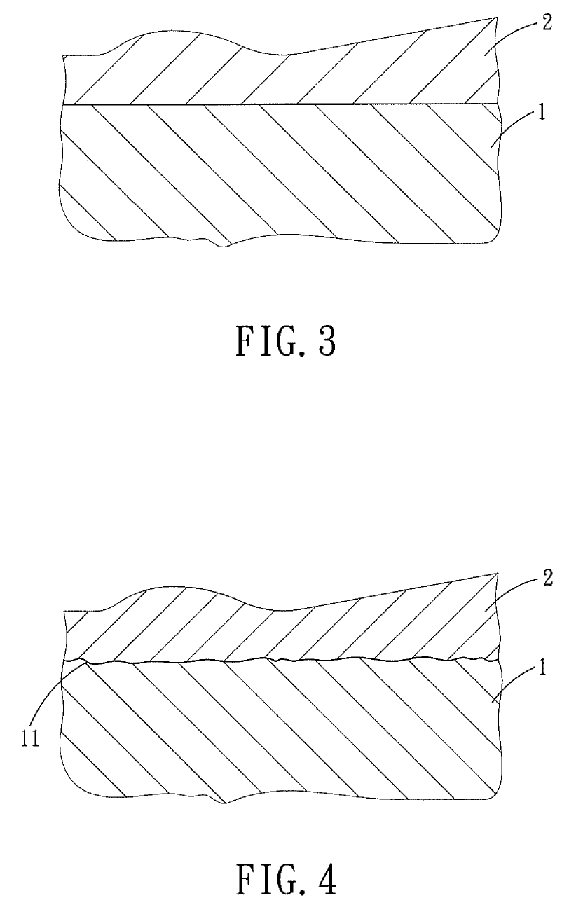

Referring to FIG. 3, which is a cross sectional view in accordance with a third embodiment of the present invention of showing a part of a multi-level color structure on a metal surface, the difference of the embodiment in FIG. 2 over that in FIG. 1 is that the Tio2 film 2 looks wavy, and the variation in thickness produces different color variations on the surface of the metal piece 1.

Finally, as shown in FIG. 4, which is a cross sectional view in accordance with a fourth embodiment of the present invention of showing a part of a multi-level color structure on a metal surface, the Tio2 film 2 also looks wavy and uneven, but the difference over the respective embodiments is that the metal piece 1 is also provided with a wavy surface 11, and the wavy surface 11 increases the thickness variation and complicacy of the Tio2 film 2, so as to produce more color variations on the surface of the metal piece 1.

While we have shown and described various embodiments in accordance with the present invention, it is clear to those skilled in the art that further embodiments may be made without departing from the scope of the present invention.

What is claimed is:

1. A multilevel color structure for a metal surface comprising a Tio2 film plated on a surface of a metal piece, the Tio2 film is inconsistent in thickness so that thickness variation of the Tio2 produces an effect of multilevel color variations through light refraction.

2. The multilevel color structure for a metal surface as claimed in claim 1, wherein the metal piece is formed with an uneven surface, and the uneven surface increases the thickness variation and complicacy of the Tio2 film.

3. The multilevel color structure for a metal surface as claimed in claim 1, wherein the Tio2 film is made by ion plating.

4. The multilevel color structure for a metal surface as claimed in claim 1, wherein the Tio2 film varies gradually in thickness, so that the Tio2 film produces gradated color.
